(19) United States
(12) Patent Application Publication
(10) Pub. No.: US 2009/0006955 A1
(43) Pub. Date: Jan. 1, 2009

(54) METHOD, APPARATUS, SYSTEM AND COMPUTER PROGRAM PRODUCT FOR SELECTIVELY AND INTERACTIVELY DOWNLOADING A MEDIA ITEM

(75) Inventors: Kongqiao Wang, Beijing (CN); Jian Ma, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/769,362

(22) Filed: Jun. 27, 2007

(51) Int. Cl. G06F 15/16; G06F 3/01

(52) U.S. Cl. 715/702; 709/219

(57) ABSTRACT

An apparatus, method, system and computer program product are provided for selectively and interactively downloading a media item, such as a video. Prior to downloading the media item, the user may first download an approximation of each group of pictures (GOPs) of the video. The user can then browse through the approximations to determine which of the GOPs to download. Each approximation may include at least part of the intra frame (“I-frame”) of the corresponding GOP. In particular, the approximation may include, only the low-frequency, component of the I-frame or the I-frame itself. Once downloaded, the approximations may be displayed, and the user may select one or more of the approximations to selectively download the corresponding GOPs. The selected GOPs may thereafter be downloaded in accordance with a selected level of specificity or detail.

### FIELD

Exemplary embodiments of the invention relate, generally, to streaming media items and, in particular, to selectively and interactively downloading streamable media items.

### BACKGROUND

With the availability of third generation (3G) and higher networks, such as Universal Mobile Telephone System (UMTS) network employing Wideband Code Division Multiple Access (WCDMA) radio access technology, and the widespread use of the existing coding standardizations (e.g., MPEG-3 or MPEG-4 (Mobile Picture Experts Group version 3 or 4)), visual information is becoming more and more important content in users' communications, and streaming media downloading is becoming more and more popular in a users' mobile experiences. However, current systems for downloading streaming media (e.g., videos, audio files, etc.) are typically not cost effective and do not take into consideration a user's preferences. In particular, in many systems, once a user clicks a link in order to access a streaming media, such as a video, the video is automatically downloaded to the user's device as a whole. In many instances, however, the user may only be interested in a part of the streaming media, and would prefer not to have to download, and, therefore, pay for, the entire streaming media item. This not only results in users having to pay more than they may want for more than they may want to receive, but it also results in excess data being transmitted over the communications networks causing unnecessary traffic.

One method that has been used to minimize downloading traffic of streaming media over the network provides a video downloading scheme adapted for the screen resolutions of mobile terminals (e.g., cellular telephone, personal digital assistant (PDA), pager, etc.). According to these systems, the resolution of the mobile terminal screen may be transmitted to the media content provider before a streamable media item is downloaded to the mobile terminal. The server may then downscale the resolution of the media item as much as possible prior to downloading the downscaled media item to the mobile terminal. While this technique may be very useful, it still requires that the user download the entire media item at once.

A need, therefore, exists for downloading scheme for streamable media that enables a user to selectively and interactively download the media item based on his/her preferences.

### BRIEF SUMMARY

In general, exemplary embodiments of the present invention provide an improvement by, among other things, providing a technique for selectively and interactively downloading a media item, such as a video. According to one exemplary embodiment, prior to downloading the video, or similar media item, the user is able to first download an approximation of each group of pictures (GOPs) of the video. The user can then browse through the approximations to determine which of the GOPs he or she would like to download. In one exemplary embodiment, each approximation may include at least a part of the intra frame (“I-frame”) of the corresponding GOP. The approximation may include, for example, only the DC, or low-frequency, component of the I-frame, or the entire I-frame itself. Once downloaded to the user's electronic device (e.g., cellular telephone, personal digital assistant (PDA), pager, personal computer (PC), laptop, etc.), the approximations may be displayed, for example, as thumbnails on the electronic device display screen, and the user may be allowed to indicate that the user either does not wish to download the corresponding GOPs, such as by selecting one or more of the approximations and dragging them to a trash bin, or that the user does wish to download the corresponding GOPs, such as by dragging them to a “display region” of the display screen of the electronic device.

Once the user has selected the GOPs he or she would like to download, the selected GOPs may be downloaded to the user's device in accordance with one of several levels of specificity or detail. In particular, where, for example, the GOPs of the media item of interest include an I-frame, one or more predictive coded frames (“P-frames”), and one or more bidirectionally predictive coded frames (“B-frames”), the user may select between four levels of download specificity. The first level may be to download only the DC, or low-frequency component of the I-frame, while the second level may be to download the entire I-frame. Where the user would like to download more details of the GOPs, the user may select a third level of download specificity, wherein the P-frames may be downloaded along with the I-frame for each GOP. Finally, a fourth level of specificity may be selected where the user prefers even more detail and does not mind downloading a significant amount of data. The fourth level may include downloading not only the I and P-frames of respective GOPs but also the B-frames (i.e., all available data for each GOP).

In accordance with one aspect, an apparatus is provided for selectively and interactively downloading a media item. In one exemplary embodiment, the apparatus may include a processor configured to: (1) display, on a display element, an approximation of respective groups of pictures of a media item comprising a plurality of groups of pictures, wherein the approximation comprises at least part of an intra frame of the corresponding group of pictures; and (2) selectively download one or more groups of pictures of the media item.

In accordance with another aspect, a method is provided for selectively and interactively downloading a media item. In one exemplary embodiment, the method includes: (1) displaying an approximation of respective groups of pictures of a media item comprising a plurality of groups of pictures, wherein the approximation comprises at least part of an intra frame of the corresponding group of pictures; and (2) selectively downloading one or more groups of pictures of the media item.

According to yet another aspect a computer program product for selectively and interactively downloading a media item is provided. The computer program product may comprise at least one computer-readable storage medium having computer-readable program code portions stored therein. In one exemplary embodiment, the computer-readable program code portions may include: (1) a first executable portion for displaying an approximation of respective groups of pictures of a media item comprising a plurality of groups of pictures, wherein the approximation comprising at least part of an intra frame of the corresponding group of pictures; and (2) a second executable portion for selectively downloading one or more groups of pictures of the media item.

According to another aspect, an apparatus is provided for selectively downloading a media item. The apparatus of one exemplary embodiment may include a processor configured to: (1) receive a request for an approximation of a media item including a plurality of groups of pictures; and (2) transmit an approximation of respective groups of pictures of the media item, wherein the approximation comprises at least part of an intra frame of the corresponding group of pictures.

In accordance with another aspect, a system is provided for selectively and interactively downloading a media item. In one exemplary embodiment, the system may include a content provider configured to receive a request for an approximation of a media item including a plurality of groups of pictures, and to transmit an approximation of respective groups of pictures of the media item, wherein the approximation comprises at least part of an intra frame of the corresponding group of pictures. The system may further include an electronic device configured to receive and display the approximation of respective groups of pictures and to selectively download from the content provider one or more groups of pictures of the media item.

According to another aspect, an apparatus is provided for selectively and interactively downloading a media item. In one exemplary embodiment, the apparatus may include: (1) a means for displaying an approximation of respective groups of pictures of a media item comprising a plurality of groups of pictures, wherein the approximation comprises at least part of an intra frame of the corresponding group of pictures; and (2) a means for selectively downloading one or more groups of pictures of the media item.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a media content provider in accordance with exemplary embodiments of the present invention;

FIG. 3 is a schematic block diagram of a mobile station capable of operating in accordance with an exemplary embodiment of the present invention;

FIG. 4 is a flow chart illustrating the selective and interactive download of a media item in accordance with exemplary embodiments of the present invention;

FIG. 5 illustrates the make-up of a Group of Pictures (GOP) of a media item or media content (e.g., a video) in accordance with an exemplary embodiment of the present invention;

FIG. 6 illustrates the DC, or low-frequency, component of an I-frame of a GOP in accordance with an exemplary embodiment of the present invention; and

FIGS. 7A-7I provide screen shots of the user interface of exemplary embodiments of the present invention that may be used to selectively and interactively download media content.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide an apparatus, method, network entity, system and computer program product for selectively and interactively downloading a media item, such as a video. As noted above, according to one exemplary embodiment, prior to downloading the video, or similar media item, to a user's electronic device, the user may be able to first download an approximation of each GOP of the video. The user can then browse through the approximations, which may be displayed on the electronic device display screen as, for example, thumbnails, to determine which of the GOPs he or she would like to download. To illustrate, as discussed in more detail below, where, for example, the user would like to begin downloading a video at a certain point other than the beginning of the video, he or she may be able to select the approximation that corresponds to the GOP at which he or she would like to begin downloading, and drag the approximation into a display region of the electronic device display screen. In one exemplary embodiment, the corresponding GOP will then be downloaded followed by the remaining GOPs of the media item. Alternatively, where, for example, the user would like to download only two or three successive GOPs, he or she may be able to select the approximations corresponding to those two or three successive GOPs and drag all of them into the display region at one time. In one exemplary embodiment, only the corresponding GOPs of the media item will then be downloaded.

In one exemplary embodiment, the user may select the level of approximation he or she would like to receive—i.e., to select how detailed he or she would like the downloaded approximations to be, as well as the level of download specificity he or she desires with respect to the GOPs ultimately downloaded to the user's device. In one exemplary embodiment, each approximation may include at least a part of the intra frame (“I-frame”) of the corresponding GOP. The approximation may include, for example, only the DC, or low-frequency, component of the I-frame, or the entire I-frame itself. With regard to the level of download specificity, as discussed above, the user may elect to have only the DC component of the I-frame of the selected GOPs, or the I-frame itself, downloaded to his or her device. Alternatively, where the user would like to download more details of the corresponding GOP, the user may elect to have both the I-frame and all of the predictive coded frames (“P-frames”) of the GOP downloaded. Where the user prefers even more detail, and does not mind downloading even more data, he or she may elect to have not only the I-frames and the P-frames of the GOP, but also all of the bidirectionally predictive coded frames (“B-frames”) of the corresponding GOP (i.e., all available data associated with each GOP).

As one of ordinary skill in the art will recognize, GOPs may include any number and combination of P and B-frames, including having no B-frames at all. In the instance where the GOPs of the media item of interest do not include B-frames, a user may only have three levels of download specificity from which to chose (i.e., DC component of I-frame; I-frame; and I and P-frames).

### Overall System and Mobile Device:

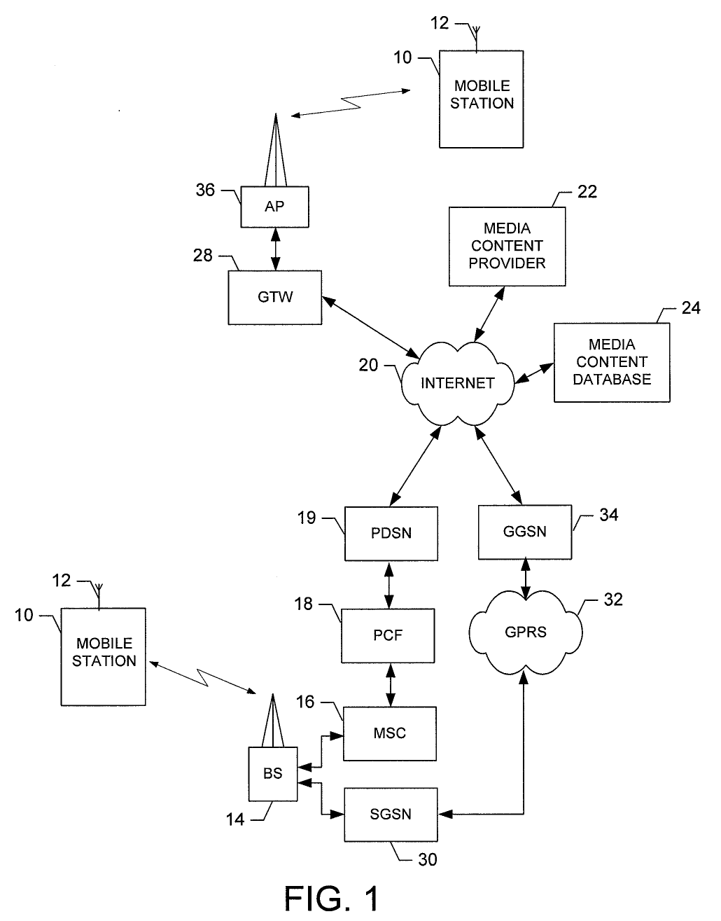

Referring to FIG. 1, an illustration of one type of system that would benefit from exemplary embodiments of the present invention is provided. As shown in FIG. 1, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a Media Content Provider 22 and/or Media Content Database 24, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including Wireless LAN (WLAN) techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., Media Content Provider 22 and/or Media Content Database 24) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to one or more processing elements (e.g., a server associated with a Media Content Provider 22 and/or Media Content Database 24) across the Internet 20, one or more such entities may be directly coupled to one another. As such, one or more network entities may communicate with one another in accordance with, for example, RF, BT, IrDA or any of a number of different wireline or wireless communication techniques, including LAN and/or Wireless LAN techniques. Further, the mobile station 10 and the processing elements can be coupled to one or more electronic devices, such as printers, digital projectors and/or other multimedia capturing, producing and/or storing devices (e.g., other terminals).

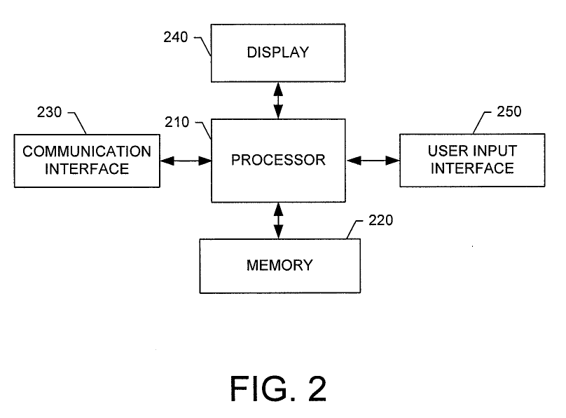

Referring now to FIG. 2, a block diagram of an entity capable of operating as a Media Content Provider 22 is shown in accordance with one embodiment of the present invention. The entity capable of operating as a Media Content Provider 22 includes various means for performing one or more functions in accordance with exemplary embodiments of the present invention, including those more particularly shown and described herein. It should be understood, however, that the entity may include alternative means for performing one or more like functions, without departing from the spirit and scope of the present invention. As shown, the entity capable of operating as a Media Content Provider 22 can generally include means, such as a processor 210, for performing or controlling the various functions of the entity. In one embodiment, the processor is in communication with or includes memory 220, such as volatile and/or non-volatile memory, that typically stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention. For example, the memory may store computer-readable program code portions or software instructions, executable by the processor 210, for receiving a request for an approximation of a media item, and, in response, transmitting an approximation of each GOP of the media item. The software instructions may further be for extracting the approximations from respective GOPs, wherein the approximations may include, for example, the DC, or low-frequency component of the I-frame of the corresponding GOP or the I-frame itself, depending, for example, upon the level of detail of the approximation requested.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

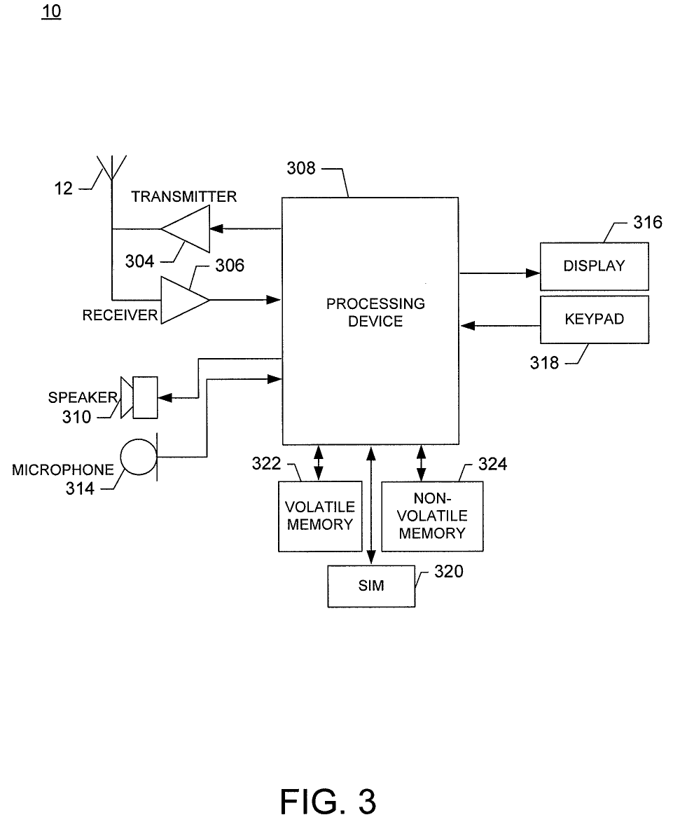

Reference is now made to FIG. 3, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that the mobile station may include alternative means for performing one or more like functions, without departing from the spirit and scope of the present invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display, or touch sensitive input device (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for receiving an approximation of respective Groups of Pictures (GOPs) of a media item, downscaling the approximations received into thumbnails, and displaying those thumbnails on the display 316 of the mobile device 10. The memory may further store computer program code for enabling a user to selectively download the groups of pictures of the media item by selecting the displayed thumbnails and dragging them into either a trashcan or bin, indicating that the user does not want to download or view the corresponding groups of pictures, or a “display region” of the display 316, indicating that the user would like to download and view the corresponding groups of pictures.

The apparatus, method, network entity, system and computer program product of exemplary embodiments of the present invention are primarily described in conjunction with mobile communications applications. It should be understood, however, that the apparatus, method, network entity, system and computer program product of embodiments of the present invention can be utilized in conjunction with a variety of other applications, both in the mobile communications industries and outside of the mobile communications industries. For example, the apparatus, method, network entity, system and computer program product of exemplary embodiments of the present invention can be utilized in conjunction with wireline and/or wireless network (e.g., Internet) applications.

### Method of Selectively and Interactively Downloading Media Content

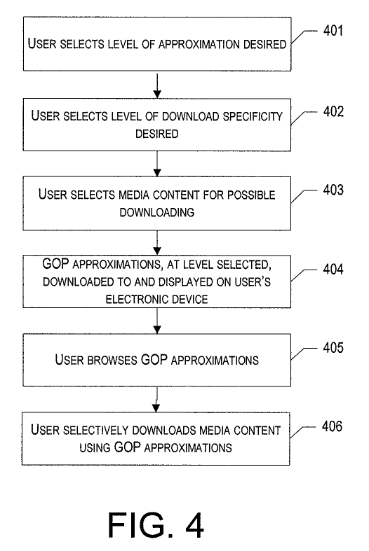

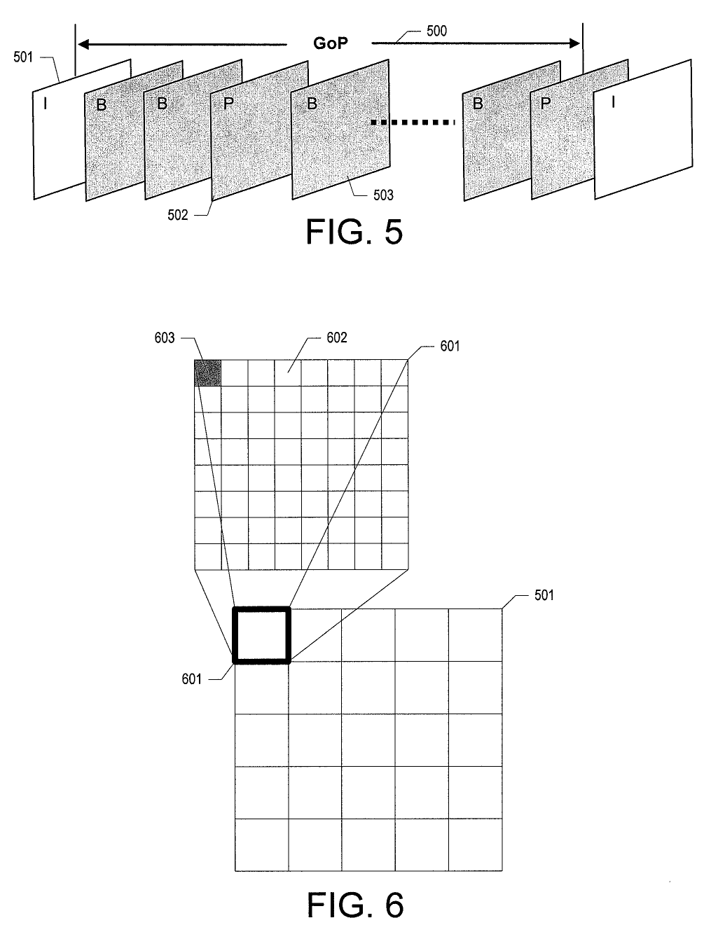

Referring now to FIG. 4, the operations are illustrated that may be taken in order to selectively and interactively download a media item to an electronic device in accordance with an exemplary embodiment. As shown, the process may begin at Block 401, when a user selects the level of approximation he or she would like to use for browsing the groups of pictures (GOPs) of the media item (e.g., video) and selecting those for further downloading. The user may also select, at Block 402, the level of specificity or detail desired in the GOPs ultimately downloaded to the user's device following selection. In particular, as one of ordinary skill in the art will recognize, a video is divided into successive GOPs, which are separately encoded. As shown in FIG. 5, each GOP 500 may be made up of a group of successive frames within a video stream, wherein the successive frames may include intra coded frames (“I-frames”) 501, predictive coded frames (“P-frames”) 502 and bidirectionally predictive coded frames (“B-frames”) 503. I-frames 501 are reference frames that correspond to fixed images and are independent of other picture/frame types. Each GOP 500 begins with an I-frame 501, which provides an approximation of the content of the GOP 500. In contrast, P-frames 502 contain difference information from the preceding I or P-frame(s), and B-frames 503 contain difference information from the preceding and/or following I or P-frame(s). In other words, while the I-frame 501 is encoded, and can, therefore be decoded, independently or without referring to any other frames, all of the P and B frames 502 and 503 will be orderly encoded, and decoded, one by one by taking the I-frame 501 as the base reference, as well as any intervening P frames 502. A GOP 500 can contain multiple P and B-frames 502 and 503. FIG. 5 is provided for exemplary purposes only and should not be taken in any way as limiting the scope of exemplary embodiments of the present invention to implementation in association with a GOP of the specific combination illustrated in FIG. 5. As one of ordinary skill in the art will recognize, media items may include GOPs made up of any number and combination of P and B-frames, all of which may be selectively downloaded in accordance with exemplary embodiments of the present invention.

Based on the foregoing, the GOPs 500 of a media item can be approximated and/or downloaded in various manners, such as by using various combinations of I-, P- and B-frames, depending upon the amount of data one wishes to download and/or the level of detail desired in the approximation and/or the ultimate download. In particular, in one exemplary embodiment, the approximation downloaded to the user's device may take one of two forms, depending, for example, on the selection made at Block 401. The first form may include the DC, or low-frequency, component of the I-frame of each GOP of the media item (i.e., video). As one of ordinary skill in the art will recognize, while I-frame coding, I-frames 501 may be encoded by block DCT (Discrete Cosine Transform) transform and coefficient quantization, during which the I-frame 501 may be divided, for example, into rows and columns of blocks 601, each made up of a predetermined number of pixels 602 (e.g., an eight-by-eight block of pixels), as illustrated in FIG. 6. In each block 601 of the I-frame DCT domain, the top-left pixel 603 is referred to as the “low-frequency,” or “DC” component of the block 601. A combination of the top-left pixels of each block in the I-frame builds the low-frequency, or DC, component of the I-frame, or the low-frequency approximation of the I-frame. Where the user selects this level of approximation, the low-frequency approximation of the I-frame, and not the I-frame itself, may be transmitted to the user for each GOP of the media item. The I-frame approximation provided by the DC, or low frequency, component reflects the content of an I-frame, which, in turn, reflects the contents of the GOP. Thus, by viewing the I-frame approximation, a user is able to briefly know the content of the GOP.

The above technique for obtaining an I-frame approximation (i.e., by combining the low-frequency, or DC, components of each block of the I-frame) may not be possible for electronic devices utilizing newer video streaming standards that require intra-block prediction (e.g., MPEG-3 and/or 4). Intra-block prediction refers to the use of each block of the I-frame to iteratively predict any subsequent blocks. Because intra-block prediction is used in these standards, the low-frequency, or DC, component cannot be directly obtained from the I-frame without first completely decoding the I-frame. Older standards, however, do not require intra-block prediction and, therefore, do support the use of a low-frequency, or DC, approximation of the I-frame.

A second form of approximation that may be selected by the user in Block 401 is the I-frame itself. In particular, the user may select to receive the entire I-frame associated with each GOP of a media item, instead of just the DC, or low-frequency, component of the I-frame. The I-frame provides more detail than the DC component and, therefore, a better representation of the GOP. However it requires an increase in the amount of data transmitted.

With regard to the level of specificity or detail of the GOP ultimately downloaded to the user's device, the user may select between at least four levels at Block 402, depending upon the makeup of the GOPs of the media item of interest. The first level may be to download only the DC, or low frequency component of the I-frame of respective GOPs. This level provides the least amount of data to be downloaded, as well as the least amount of detail of the GOP. The second level of download specificity may be to download the entire I-frame itself; thus requiring slightly more data to be downloaded, but at the same time providing slightly more detail. According to one exemplary embodiment, the third level that may be selected may include the I-frame as well as any P-frames in the GOP. This level provides even further detail while requiring the transmission of even more data. Finally, the fourth level that may be selected may include the I and P-frames, as well as any B-frames in the GOP. As one of ordinary skill in the art will recognize, this level of download specificity, which provides the most detail and requires transmission of the most data, may not be available where the GOP comprises only I and P-frames, and no B-frames.

In order to select the level of approximation and/or download specificity the user would like to receive, such as from among those forms and levels discussed above, he or she may first access a website operated by the Media Content Provider 22, from which the user wishes to download a media item, and then select the level from a listing of levels provided on the website. Alternatively, the user's electronic device may request and store the user's preference for the level of approximation and/or download specificity he or she would like to receive. In particular, the electronic device may, for example, provide one or more buttons (soft or hard), which the user can use to select the level of approximation and/or download specificity. Thereafter, the electronic device may communicate this selection to the Media Content Provider 22 once the user has selected the media item for possible downloading, in Block 403. In one exemplary embodiment, selection of the level of approximation and/or download specificity may occur only once (e.g., when the user first initializes his or her electronic device, browser, or the like). In this exemplary embodiment, the user may only be required to perform Blocks 401 and/or 402 when he or she would like to change the level of approximation and/or download specificity received. Otherwise, the electronic device may store the user's selection and communicate this information to the Media Content Provider 22 each time the user selects a media item for possible downloading (i.e., Block 403). In order to select the media item for possible downloading, at Block 403, the user (e.g., a browser operating on the user's electronic device) may access the website provided by the Media Content Provide 22 and then click on or select a link provided by that website to the desired media item.

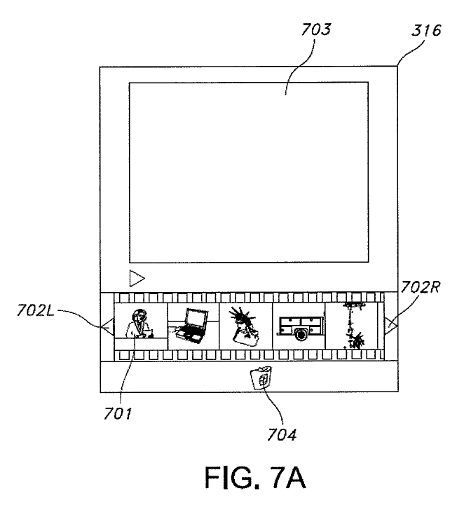

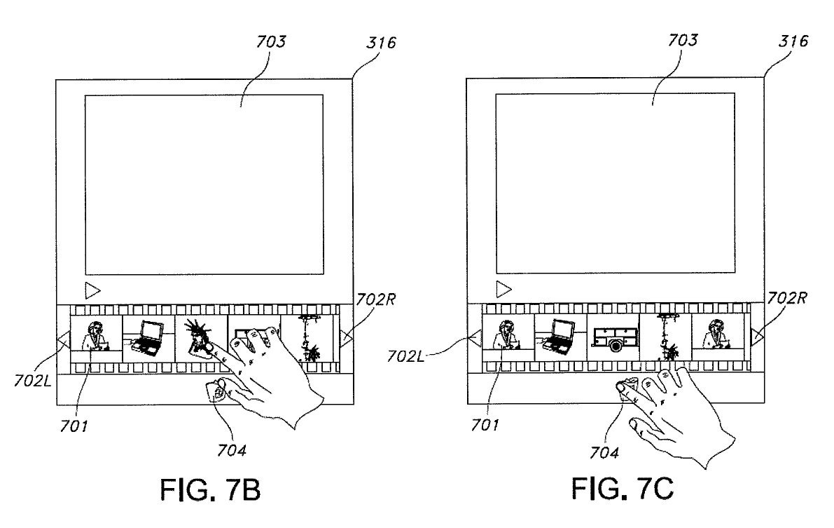

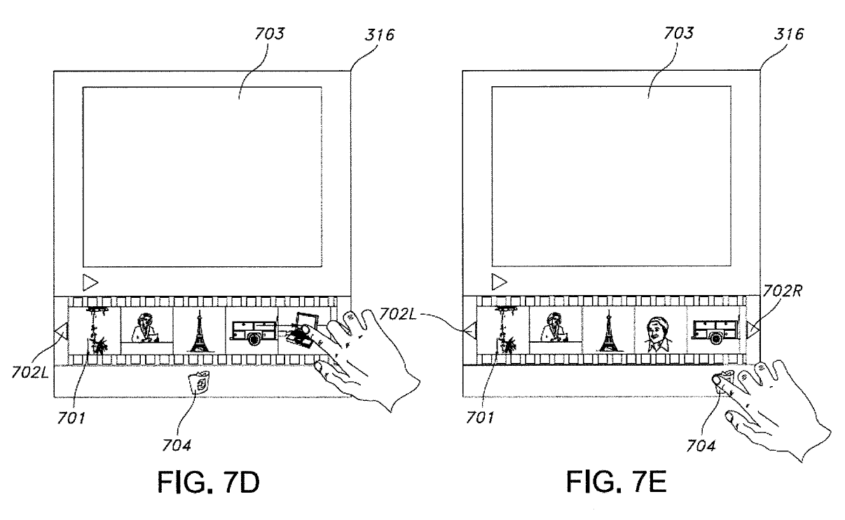

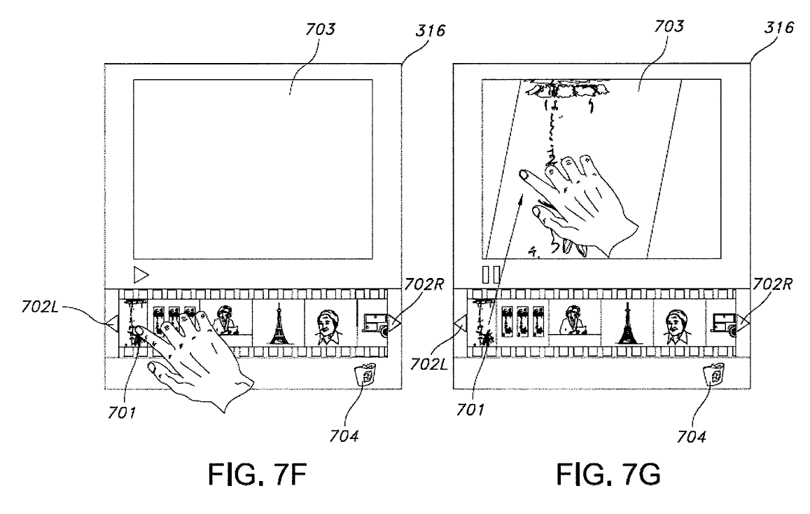

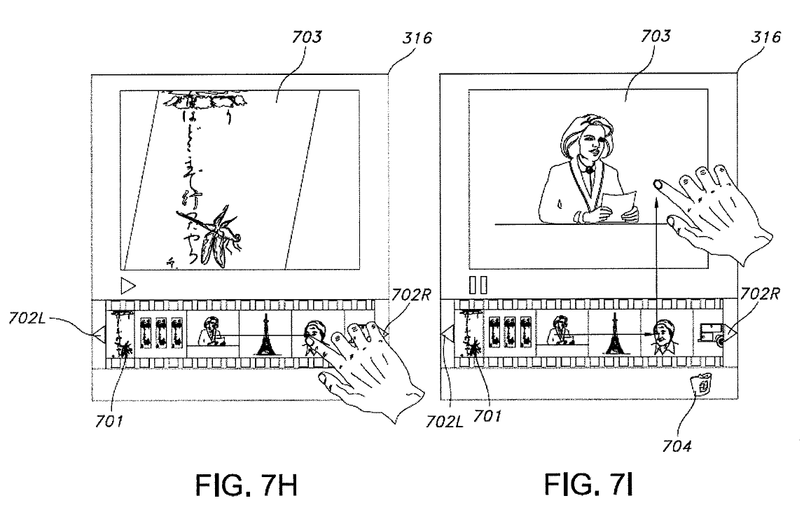

Once the level of approximation and/or download specificity and the media item for possible downloading have been selected, at Block 404, an approximation of each GOP, or GOPs occurring at a certain interval, of the media item may be downloaded to the user's electronic device from the Media Content Provider 22, in accordance with the user's selections, and displayed on the display screen 316 of the electronic device (e.g., by an application stored on the electronic device and executed by a processor of the electronic device). In one exemplary embodiment, prior to displaying the approximations, the electronic device and, for example, more specifically an application executed on the electronic device by a processor, may downscale each approximation such that only a thumbnail is displayed in association with each GOP approximation. As shown in FIG. 7A, which is discussed in more detail below, these thumbnails may be displayed, for example, along the bottom of the electronic device display screen 316 leaving a display region for displaying the actual GOP(s) once they are downloaded on the display screen 316.

At Block 405, the user is able to browse through the approximations in order to determine which of the corresponding GOPs he or she would like to further download. In particular, as discussed in more detail below in relation to FIG. 7A, the user may use directional keys of a Navi-key or joystick of the electronic device to scan back and forth through the approximations of the GOPs of the media item and to select the GOPs to download and/or the GOPs not to download. At Block 406, the user can then selectively download the GOPs of the media item, based on viewing and browsing the approximations of those GOPs. For example, as discussed in more detail below with regard to FIGS. 7A-7I, the user may determine from looking at the approximation of a particular GOP that the scene in a video associated with that GOP is boring and desire, therefore, not to download that GOP. Similarly, the user may determine that a specific two or three scenes are very interesting and desire, therefore, to download and view the GOPs associated with those scenes over and over again. The user interface of exemplary embodiments allows the user to do both. According to one exemplary embodiment, the GOPs may be downloaded at Block 406 based on the level of download specificity selected by the user at Block 402 (e.g., DC component of I-frame only; I-frame; I and P-frames; or I, P and B-frames).

FIGS. 7A through 7I illustrate the display screen of an electronic device when the process described above is being implemented in accordance with one exemplary embodiment. As shown, in FIG. 7A the approximations 701 of a plurality of GOPs of a media item may be displayed by the electronic device (i.e., an application executed on the electronic device by a processor) in a row along the bottom of the electronic device display screen 316 in chronological order. The user may be able to browse through the approximations 701 using the left and right arrows 702L and 702R, displayed on either side of the approximations 701. In particular, the user may actuate either arrow 702L, 702R using, for example, his or her finger, a stylus, or the like, in order to cause the approximations 701 displayed to move to either the left or the right and to display new approximations 701 in either direction.

As shown in FIGS. 7B and 7C, in one exemplary embodiment, in order for the user to remove one or more GOPs from the plurality of GOPs of a media item that the user wishes to download, the user may select the approximation 701 of that GOP and drag the approximation 701 into a trashcan or bin 704. In particular, the user may touch the display screen 316 at the location at which the approximation 701 is displayed, and move his or her finger to the location at which the trashcan or bin 704 is displayed without lifting his or her finger. Similarly, as shown in FIGS. 7D and 7E, a user can remove several GOPs at one time from the GOPs that will be subsequently downloaded, by selecting all of the approximations at once and dragging them to the trashcan 704 (e.g., by touching the display screen at the location at which the first approximation is displayed, moving his or her finger to the location at which the last approximation is displayed, and then moving his or her finger to the location at which the trashcan is displayed, all the while without lifting his or her finger from the display screen).

FIGS. 7F and 7G illustrate one way in which a user may select where in a successive stream of GOPs the user would like to begin downloading, in accordance with one exemplary embodiment. As shown, the user may first select the approximation 701 associated with the GOP at which the user would like to begin downloading and then drag this approximation 701 to the display region 703 of the display screen 316. As above, this may be performed, for example, by touching the display screen 316 at the location at which the approximation 701 is displayed, and then moving his or her finger, stylus, or the like, to the location at which the display region 703 is displayed. Once the user has so selected the starting GOP, in one exemplary embodiment, the GOPs of the media item may be downloaded to the electronic device beginning with the GOP corresponding with the selected approximation. Where, for example, the user has previously “trashed” some of the approximations, for example, in the manner discussed above with regard to FIGS. 7B-7E, the GOPs corresponding with the “trashed” approximations will not be downloaded at this point.

FIGS. 7H and 7I similarly illustrate one way in which a user may use the user interface of one exemplary embodiment in order to selectively download two or more GOPs of a media item and, for example, view them over and over. In this exemplary embodiment, the user may select the two more approximations 701 associated with the two or more GOPs he or she desires to download (e.g., by touching the display screen at the location of the first approximation and moving his or her finger to the location of the last approximation, without lifting up), and then drag those approximations to the display region 703 of the display screen (e.g., by then moving his or her finger to the location at which the display region is displayed, all without lifting up).

Based on the foregoing, exemplary embodiments provide a new experience for a user when streaming media content to his or her electronic device that allows the user to selectively and interactively download the media content according to their preferences and needs. Exemplary embodiments, therefore, maximize the downloading efficiency of streaming media and provide an overall more cost-effective way to download streamable media to an electronic device.

### CONCLUSION

As described above and as will be appreciated by one skilled in the art, embodiments of the present invention may be configured as a apparatus, method, network entity and system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
display an approximation of respective groups of pictures of a media item comprising a plurality of groups of pictures, said approximation comprising at least part of an intra frame of the corresponding group of pictures; and
selectively download one or more groups of pictures of the media item.

2. The apparatus of claim 1, wherein the approximation comprises a low-frequency component of the intra frame.

3. The apparatus of claim 1, wherein the approximation comprises the whole intra frame.

4. The apparatus of claim 1, wherein in order to selectively download one or more groups of pictures of the media item, the processor is further configured to download a low-frequency component of an intra frame of respective groups of pictures.

5. The apparatus of claim 1, wherein in order to selectively download one or more groups of pictures of the media item, the processor is further configured to download an intra frame of respective groups of pictures.

6. The apparatus of claim 5, wherein in order to selectively download one or more groups of pictures of the media item, the processor is further configured to download one or more predictive coded frames of respective groups of pictures.

7. The apparatus of claim 6, wherein in order to selectively download one or more groups of pictures of the media item, the processor is further configured to download one or more bidirectionally predictive coded frames of respective groups of pictures.

8. The apparatus of claim 1, wherein the processor is further configured to:
receive the approximation of respective groups of pictures of the media item; and
downscale the respective approximations, such that displaying the approximation comprises displaying a corresponding downscaled representation.

9. The apparatus of claim 1 further comprising:
an input device configured to receive a selection of one or more approximations displayed by the processor, said input device further configured to receive an instruction to remove one or more groups of pictures corresponding with the one or more approximations selected from the one or more groups of pictures to be selectively downloaded or to download one or more groups of pictures represented by the one or more approximations selected.

10. The apparatus of claim 9, wherein in order to selectively download the one or more groups of pictures of the media item, the processor is further configured to download the one or more groups of pictures based at least in part on the instruction received by the input device.

11. The apparatus of claim 9, wherein the input device is further configured to receive an indication of a requested level of download specificity, and wherein in order to selectively download one or more groups of pictures of the media item, the processor is further configured to selectively download the one or more groups of pictures in accordance with the level of download specificity requested.

12. The apparatus of claim 1, further comprising a display element comprising a touch sensitive input device configured to receive a selection of one or more approximations displayed on the touch sensitive input device, said touch sensitive input device further configured to receive an instruction to remove one or more groups of pictures corresponding with the one or more approximations selected from the one or more groups of pictures to be selectively downloaded or to download one or more groups of pictures represented by the one or more approximations selected.

13. A method comprising:
displaying an approximation of respective groups of pictures of a media item comprising a plurality of groups of pictures, said approximation comprising at least part of an intra frame of the corresponding group of pictures; and
selectively downloading one or more groups of pictures of the media item.

14. The method of claim 13, wherein the approximation comprises a low-frequency component of the intra frame.

15. The method of claim 13, wherein the approximation comprises the whole intra frame.

16. The method of claim 13, wherein selectively downloading one or more groups of pictures of the media item further comprises selectively downloading a low-frequency component of an intra frame of respective groups of pictures.

17. The method of claim 13, wherein selectively downloading one or more groups of pictures of the media item further comprises selectively downloading an intra frame of respective groups of pictures.

18. The method of claim 17, wherein selectively downloading one or more groups of pictures of the media item further comprises selectively downloading one or more predictive coded frames of respective groups of pictures.

19. The method of claim 18, wherein selectively downloading one or more groups of pictures of the media item further comprises selectively downloading one or more bidirectionally predictive coded frames of respective groups of pictures.

20. The method of claim 13 further comprising:
receiving the approximation of respective groups of pictures of the media item; and
downscaling the respective approximations, such that displaying the approximation comprises displaying a corresponding downscaled representation.

21. The method of claim 13 further comprising:
receiving a selection of one or more approximations displayed; and
receiving an instruction to remove one or more groups of pictures corresponding with the one or more approximations selected from the one or more groups of pictures to be selectively downloaded or to download one or more groups of pictures represented by the one or more approximations selected.

22. The method of claim 21, wherein selectively downloading the one or more groups of pictures of the media item, comprises downloading the one or more groups of pictures based at least in part on the instruction received.

23. The method of claim 21 further comprising:
receiving an indication of a requested level of download specificity, wherein selectively downloading one or more groups of pictures of the media item comprises downloading the one or more groups of pictures in accordance with the level of download specificity requested.

24. A computer program product comprising at least one computer-readable storage medium having computer-readable program code portions stored therein, the computer-readable program code portions comprising:
a first executable portion for displaying an approximation of respective groups of pictures of a media item comprising a plurality of groups of pictures, said approximation comprising at least part of an intra frame of the corresponding group of pictures; and
a second executable portion for selectively downloading one or more groups of pictures of the media item.

25. The computer program product of claim 24, wherein the approximation comprises a low-frequency component of the intra frame.

26. The computer program product of claim 24, wherein the approximation comprises the whole intra frame.

27. The computer program product of claim 24, wherein the second executable portion is configured to selectively download a low-frequency component of an intra frame of respective groups of pictures.

28. The computer program product of claim 24, wherein the second executable portion is configured to selectively download an intra frame of respective groups of pictures.

29. The computer program product of claim 28, wherein the second executable portion is further configured to selectively download one or more predictive coded frames of respective groups of pictures.

30. The computer program product of claim 29, wherein the second executable portion is further configured to selectively download one or more bidirectionally predictive coded frames of respective groups of pictures.

31. The computer program product of claim 24, wherein the computer-readable program code portions further comprise:
a third executable portion for receiving the approximation of respective groups of pictures of the media item; and
a fourth executable portion for downscaling the respective approximations, such that displaying the approximation comprises displaying a corresponding downscaled representation.

32. The computer program product of claim 24 further comprising:
a third executable portion for receiving a selection of one or more approximations displayed; and
a fourth executable portion for receiving an instruction to remove one or more groups of pictures corresponding with the one or more approximations selected from the one or more groups of pictures to be selectively downloaded or to download one or more groups of pictures represented by the one or more approximations selected.

33. The computer program product of claim 32, wherein the second executable portion is further configured to download the one or more groups of pictures based at least in part on the instruction received.

34. The computer program product of claim 32, wherein the computer-readable program code portions further comprise:
a fifth executable portion for receiving an indication of a requested level of download specificity, wherein the second executable portion is configured to selectively download the one or more groups of pictures in accordance with the level of download specificity requested.

35. An apparatus comprising:
a processor configured to:
receive a request for an approximation of a media item, said media item comprising a plurality of groups of pictures; and
transmit an approximation of respective groups of pictures of the media item, said approximation comprising at least part of an intra frame of the corresponding group of pictures.

36. The apparatus of claim 35, wherein the processor is further configured to extract the approximation from respective groups of pictures of the media item.

37. The apparatus of claim 36, wherein the approximation comprises a low-frequency component of the intra frame.

38. The apparatus of claim 36, wherein the approximation comprises the whole intra frame.

39. A system comprising:
a content provider configured to receive a request for an approximation of a media item comprising a plurality of groups of pictures, and to transmit an approximation of respective groups of pictures of the media item, said approximation comprising at least part of an intra frame of the corresponding group of pictures; and
an electronic device configured to receive and display the approximation of respective groups of pictures and to selectively download from the content provider one or more groups of pictures of the media item.

40. The system of claim 39, wherein the approximation comprises a low-frequency component of the intra frame.

41. The system of claim 39, wherein the approximation comprises the whole intra frame.

42. The system of claim 39, wherein the electronic device is configured to receive a selection of one or more approximations displayed, and an instruction to remove one or more groups of pictures corresponding with the one or more approximations selected from the one or more groups of pictures to be selectively downloaded or to download the one or more groups of pictures represented by the one or more approximations selected.

43. The system of claim 42, wherein in order to selectively download the one or more groups of pictures of the media item, the electronic device is further configured to download the one or more groups of pictures based at least in part on the instruction received.

44. The system of claim 39, wherein the electronic device is further configured to receive an indication of a requested level of download specificity, and wherein in order to selectively download one or more groups of pictures of the media item, the electronic device is further configured to download the one or more groups of pictures in accordance with the level of download specificity requested.

45. An apparatus comprising:
a means for displaying an approximation of respective groups of pictures of a media item comprising a plurality of groups of pictures, said approximation comprising at least part of an intra frame of the corresponding group of pictures; and
a means for selectively downloading one or more groups of pictures of the media item.
